(19) United States
(12) Patent Application Publication
(10) Pub. No.: US 2013/0303112 A1
(43) Pub. Date: Nov. 14, 2013

(54) TRACKING OF MISSING COMMUNICATION DEVICES

(71) Applicant: Mahendra Chhipa, Gurgaon (IN)

(72) Inventor: Mahendra Chhipa, Gurgaon (IN)

(73) Assignee: Telefonaktiebolaget L M Ericsson (PUBL), Stockholm (SE)

(21) Appl. No.: 13/977,626

(22) PCT Filed: Dec. 30, 2010
(86) PCT No.: PCT/SE10/51498

§ 371 Date: Jun. 28, 2013

(51) Int. Cl. H04W 12/12; H04B 1/38

(52) U.S. Cl. CPC H04W 12/12; H04B 1/3816
USPC 455/405

(57) ABSTRACT

Embodiments of method for determining information associated with an unregistered usage of a mobile communication device are disclosed. In an embodiment, the method includes registering a Subscriber Identification Module (SIM) at the mobile communication device. The method further includes determining, at the mobile communication device, usage of an unregistered SIM based at least in part on pre-stored information corresponding to the registered SIM. The method also includes communicating the determined usage to an operator subsystem and determining, at the operator subsystem, based on the communication, user information associated with the registered SIM and the unregistered SIM.

### TECHNICAL FIELD

Implementations described herein relate generally to mobile communication devices, and more particularly, to systems and methods for tracking a missing mobile communication device.

### BACKGROUND

With the advent of advanced communication technologies and incorporation of various standards associated with mobile communication services and telecommunication networks, mobile communication devices (e.g. cell phones, personal digital assistants, notebooks, tablet PCs, smart phones, etc.) have become an inseparable part of our lives. For instance, survey statistics indicate that around 61% of the world's population have subscribed to mobile communication services and are using a mobile device. Based on the above statistics, there are around 4.1 billion mobile phones in use currently across the globe.

Due to ever increasing demand and tough competition, the cost of manufacturing mobile communication devices, such as, mobile phones has come down drastically in the last few decades. A lot of manufacturers are operating in this market segment and consequently a variety of mobile phones with multiple features is available of the shelf at very attractive prices. Concomitant with such a convenient and cheap access to mobile phones, are undesirable events such as, mobile theft, masquerading of mobile data, breach of privacy, misuse of mobile phones, unauthorized use, etc. A host of security features has come up in the recent years addressing one or more of the above mentioned concerns but there still exists a need for fool proof solution for mobile phone thefts and unauthorized use of mobile phones. Majority of mobile phone thefts are carried out with an intention to reuse the mobile phone or sell it for money.

Mobile communication devices, such as, mobile phones, typically include a Subscriber Identity Module (SIM) that is programmed on a removable SIM card. The SIM card securely stores service-subscriber key—International Mobile Subscriber Identity (IMSI) used to identify a subscriber on mobile communication devices (such as mobile phones and computers). The SIM card also allows users to change mobile phones by simply removing the SIM card from one mobile phone and inserting it into another mobile phone or broadband communication devices. A SIM card contains its unique serial number, internationally unique number (IMSI) of the mobile user (IMSI), security authentication and ciphering information, temporary information related to the local network, a list of the services the user has access to and two passwords (PIN for usual use and PUK for unlocking).

Typically, network operators (or service providers) provide such SIM cards to a user who subscribes to their network. For billing and record keeping, the network operators maintain a database of subscribers, their international unique identification number, name, address, date of birth, and other customer demographic details. Such data bases are implemented in charging systems of the network operators and the content thereof is designated as “private and confidential” as per the service agreement between the subscriber and the network service provider. Since, the SIM card is physically removable; the mobile phone can be stolen and used by any third party just by removing the owner's SIM card and inserting a new SIM card. The new SIM card may be purchased from the same network operator (that issued the original SIM card).

One of the existing solutions was a mobile device with a non-removable SIM card. Such a solution requires collaboration between mobile device manufacturers and service providers. The mobile device manufacturer would irremovably insert a SIM card (from the service provider) at the time of manufacturing and modifies the body of the mobile device in such a manner that the SIM card cannot be seen or taken out by a user. This solution renders the mobile device and the SIM card inseparable and therefore the possibility of using the mobile device with any other SIM from a different operator is eliminated. This form of mobile device-SIM card interdependence and negligible resale value of the mobile device discourages an unauthorized user from illegally acquiring the mobile device and using the same. Although, this solution is effective, the owner of the mobile device has no flexibility of using the same mobile device with a different SIM card. Moreover, statistics show that on an average, mobile phone users change their mobile phones after every 18 months. With such a short period of usage, the above solution may be unattractive in the long run.

Yet another existing solution is to detect the removal of a registered SIM and insertion of an unregistered SIM. Based upon such detection, a warning message is triggered to a predetermined destination. In patent publication US200610276175, a method of tracking a lost mobile electronic device connected to a wireless or wired network is provided. The method includes storing user identity information included in a user identity card inserted into the mobile device, a warning message, and information regarding a destination number of the users mobile electronic device. When a new user identity card is inserted into the mobile device, the method includes comparing user identity information stored in the new user identity card with the stored user identity information. The method further includes automatically transmitting the warning message to the destination of the warning signal if the user identity information stored in the new user identity card is not identical to the stored user identity information.

Such a solution may not be fool proof because the solution is essentially implemented inside the mobile communication device and may be tampered with during a complete software removal process in the mobile communication device. There are no components at the network operator site and hence communication is essentially between mobile communication devices only. Secondly, the warning message contains location information and the International Mobile Subscriber Identity (IMSI) number of the unauthorized user. Based on such a warning message, it may be difficult to track the lost or stolen device because the location information gives the location of the communication device at the time and place where the new user identity card (SIM card) has been changed. The unauthorized user may move away from that location and may keep moving to other locations. Thus, the exact location identification of the user is still difficult to determine and hence tracking and acquiring the mobile communication device back from the user is difficult.

Other solutions include similar modules or systems that are installed at the mobile communication device that sends a warning message, location information, call details of the unauthorized user, etc. to a predetermined destination. Some other solutions may block or disable the services of the mobile communication device. Existing solutions do solve the problem to some extent but there is still a well felt need for an improved system and method that helps in tracking a missing mobile communication device and retrieving the same in a cost and time efficient manner.

In view of the above, it is desirable to have a simple yet effective system that addresses at least the above mentioned disadvantages in the art.

### SUMMARY

It is an object of the present invention to obviate at least some of the above disadvantages and provide an improved system and method for tracking and retrieving missing mobile communication devices.

It is a further object of the present invention to provide simple yet effective system and method for tracking of stolen mobile phones.

It is yet another object of the present invention to provide a method for providing name, location, address and other details of an unauthorized user of a mobile communication device.

It is another object of the present invention to provide systems for detecting the use of an unregistered SIM and possible misuse of a mobile communication device.

Embodiments of a method for determining unregistered usage of a mobile communication device are disclosed. The mobile communication device is pre-associated with a registered Subscriber Identification Module (SIM). In accordance with an embodiment, the method includes detecting service initiation of an unregistered SIM in the mobile communication device and receiving a notification associated with the detected service initiation. The notification includes Mobile Station International ISDN Numbers (MSISDN) corresponding to the registered SIM and the unregistered SIM respectively. The method further includes determining, based on the notification, user details associated with the registered SIM and the unregistered SIM and communicating the user details corresponding to unregistered SIM to a user associated with the registered SIM.

Implementations and embodiments of system are disclosed for tracking unregistered usage of a mobile communication device. The mobile communication device is pre-associated with a registered Subscriber Identification Module (SIM). In an implementation, the system includes a network component executing at an operator subsystem that receives a notification of unregistered usage from the mobile communication device and determines user details associated with the unregistered usage. The network component further communicates the determined user details to a user associated with the registered SIM. In yet another embodiment, the system includes a mobile component installed in the mobile communication device configured to detect usage of an unregistered Subscriber Identification Module.

Additional features of the invention will be set forth in the description that follows, and in part will be obvious from the description, or may be learned by the practice of the invention.

The features and advantages of the invention may be realized and obtained by means of the system and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail with the accompanying drawings in which:

FIG. 1 illustrates an exemplary system for tracking unregistered usage of a mobile communication device;

FIG. 2 illustrates an embodiment of system for tracking unregistered usage of a mobile communication device;

FIG. 3 illustrates an exemplary signaling diagram between modules of FIG. 2 according to an implementation; and

FIG. 4 illustrates an exemplary method for determining unregistered usage of a mobile communication device according to an implementation.

### DETAILED DESCRIPTION

The following detailed description of the invention refers to the accompanying drawings. The same reference numbers in different drawings may identify the same or similar elements. In addition, the following detailed description does not limit the invention.

The following terms, wherever used within the ongoing description, may be construed as per the definition given below:

Registered subscriber identification module (SIM): can be defined as SIM that is registered with mobile component 108 in mobile communication device 102. It also corresponds to an authorized SIM card that belongs to the owner of the mobile communication device 102.

Unregistered SIM: can be defined as the SIM that is not registered with the mobile component 108 in the mobile communication device 102. It also corresponds to an unauthorized SIM card belonging to a thief or a person who has wrongfully obtained the mobile communication device 102 and is not the owner thereof.

As described earlier, growing number of mobile thefts, technical difficulties in tracking the stolen device, loop holes in the existing methods, and the complex procedures involved in registering a complaint and getting back the device necessitates the need for a simpler, yet effective solution. Systems and methods are disclosed for tracking unregistered usage of a mobile communication device. The disclosed systems and methods make use of the existing infrastructure, such as, operator side network components, to track an unauthorized usage of a mobile communication device. In addition to tracking, the systems and methods enable owners of mobile communication devices to retrieve their devices easily.

In an embodiment, method for determining information associated with an unregistered usage of a mobile communication device includes registering a Subscriber Identification Module (SIM) at the mobile communication device. The method further includes determining, at the mobile communication device, usage of an unregistered Subscriber Identification Module based at least in part on pre-stored information corresponding to the registered Subscriber Identification Module. The method includes communicating the determined usage to an operator subsystem and determining, at the operator subsystem, based on the communication, user information associated with the registered Subscriber Identification Module and the unregistered Subscriber Identification Module

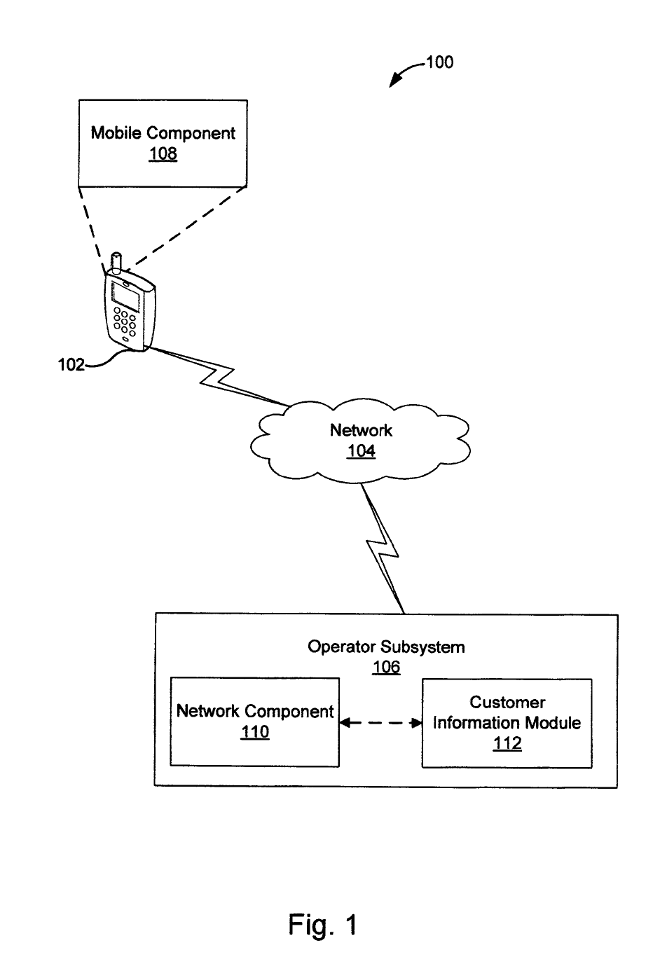

Referring to FIG. 1, an exemplary system for tracking unregistered usage of a mobile communication device is illustrated. Accordingly, the system 100 includes a mobile communication device 102 owned by a first user. The mobile communication device 102 communicates through a network 104 and may be a smart phone, a laptop, a personal digital assistant, a mobile phone, a notebook, a tablet PC or the like. It may be noted that the teachings of the disclosed invention can be extended to all those mobile communication devices that have the feature of inserting a user identity card in order to communicate through a network. In an exemplary embodiment, the network 104 corresponds to a mobile communication network, such as, Global System for Mobile Communications (GSM) networks.

The system 100 further includes an operator subsystem 106 installed at network operator or service provider's site. The network operator maintains and operates the operator subsystem 106 as part of providing mobile communication services to the mobile communication device 102. The mobile communication device 102 includes a mobile component 108 that manages the user information associated with the owner of the mobile communication device 102. The mobile component 108 may be application software, a code, a set of instructions, stored in memory of the mobile communication device 102.

In an embodiment, the mobile component 108 can be configured to be a part of default factory settings hardwired by mobile device manufacturers. It is desirable that the mobile component 108 once installed and activated should be up and running always irrespective of the type of usage and the state of the mobile communication device 102. One of the ways to achieve this is to store the mobile component 108 in a non-volatile memory of the mobile communication device 102. Another way is to designate a memory sector in the memory that would need unique password to be overwritten or modified. Such a password can be either set by the device manufacturer or may be set by the owner of the mobile communication device. In such a scenario, the mobile component 108 and the associated functionality becomes an added feature of the mobile communication device 102.

In an alternative embodiment, the mobile component 108 can correspond to an application software or 3^{rd} party program developed by a third party other than the mobile device manufacturer. For example, the mobile component 108 may correspond to a JAVA based application. Such application software can be made available in computer readable media accessible by the mobile communication device 102. Computer readable media can include a compact disc (CD), a digital video disc (DVD), or flash memory. Other types of portable storage media may be used for the purposes of shipping the application software to the end user. In yet another implementation, the mobile component 108 can be made available on internet and the mobile communication device 102 can download the mobile component 108 upon payment of license fee associated with the mobile component 108, if applicable. In one of the implementations, the mobile component 108 may be application software developed by the network operator or the service provider. The service provider can offer the mobile component 108 and allied features as a part of mobile communication services to the subscribers. Such value added services can be a unique selling point (USP) of the service provider and give a competitive edge over the competitors.

On the network operator's side, the operator subsystem 106 includes one or more modules such as, a network component 110 and a customer information module 112. In an implementation, the network component 110 may correspond to application software developed by the network operator/3^{rd} party developer. The network component 110 is configured to receive notifications from the mobile communication device 102 regarding an unauthorized usage of the mobile communication device 102. The network component 110 accesses the customer information module 112 to determine information associated with the unauthorized usage.

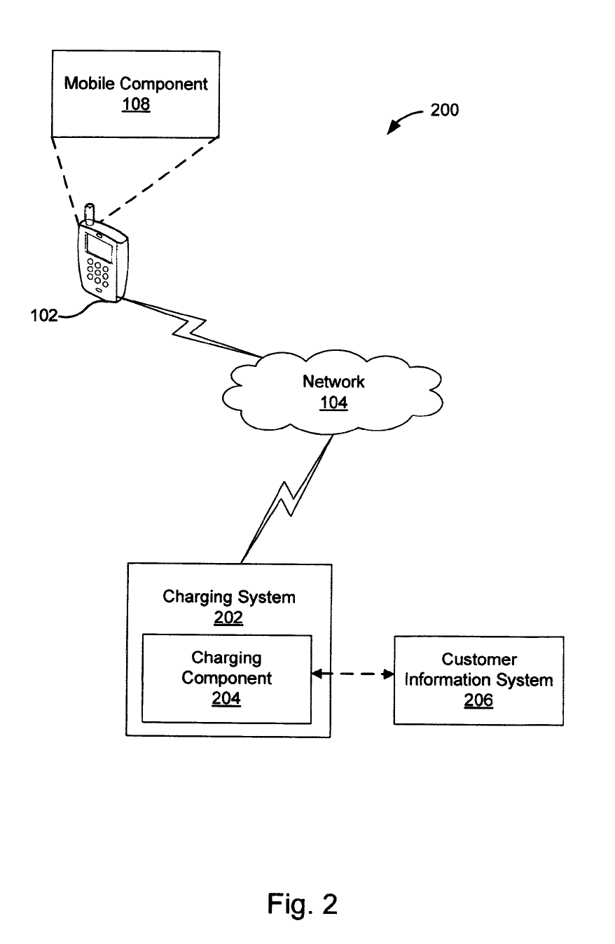

FIG. 2 shows yet another embodiment of a system 200 for tracking an unregistered usage of a mobile communication device. In an exemplary embodiment, the operator subsystem 106 of system 100 can correspond to charging system 202 as shown in FIG. 2. The charging system 202 includes a charging component 204 that is configured to function as the network component 110 in operator subsystem 106 of system 100. The system 200 also includes a proprietary customer information system 206 that corresponds to customer information module 112 of FIG. 1. As shown in FIG. 2, the charging component 204 and the proprietary customer information system 206 may be implemented as separate modules or can be a part of single module such as the charging system 202.

The mobile communication device 102 would generally contain a user's subscriber identification module (SIM) obtained from a service provider. Referring to FIG. 1, the mobile component 108 registers a Subscriber Identification Module (SIM) at the mobile communication device 102. Such a registration can be performed when the mobile component 108 is activated by the mobile owner. The mobile component 108 can be activated by selecting a display icon that appears on the menu of the mobile communication device 102. The selection can be performed by using input means available on all standard mobile communication devices 102. Upon selection, the mobile component 108 can be executed in the mobile communication device 102. During the activation, the mobile component 108 may prompt the user (mobile owner) to enter one or more passwords. The one or passwords may be provided by the device manufacturer (or the service provider or 3^{rd} party developer) in an operator manual.

In an implementation, the mobile component 108 may be so configured that the registration is performed automatically when the SIM card is inserted for the first time. The mobile component 108 may prompt the owner of the mobile communication device 102 to authorize such automatic registration. Irrespective of the method of activation and registration, the mobile component 108 stores user information associated with the owner of the mobile communication device 102. Such user information can include the Mobile Subscriber Integrated Services Digital Network Number (MSISDN) associated with the registered SIM and a destination number (of the network component 110) for sending a notification. The SIM registered with the mobile component 108 will be referred to as registered SIM for the purposes of ongoing description.

In a successive progression, the mobile component 108 determines, at the mobile communication device 102, the usage of an unregistered SIM. Such a determination is based at least in part on the pre-stored user information corresponding to the registered SIM. In an implementation, the mobile component 108 compares the MSISDN associated with an unregistered SIM and the registered SIM. As described earlier, a new user would insert a new SIM that is not registered with the mobile component 108. The mobile component 108 detects the insertion of the unregistered SIM as soon as the mobile communication device 102 is powered on after inserting the unregistered SIM.

The mobile component 108 then communicates the determined usage to the operator subsystem 106. In an embodiment, the mobile component 108 obtains the MSISDN from the unregistered SIM and the registered SIM and constructs a message. Such a message can correspond to a short message service (SMS) notification. The mobile component 108 sends the SMS or the notification to the operator subsystem 106.

At the operator subsystem 106, the network component 110 determines user information associated with the registered SIM and the unregistered SIM based on the received notification (e.g. SMS). The network component 110 extracts the MSISDN associated with the unregistered SIM and the registered SIM respectively and determines the corresponding user information. In an implementation, the user information includes one or more of name, home address, and email address of users associated with the registered SIM and the unregistered SIM.

The network component 110 communicates the user information associated with the unregistered SIM to a user associated with the registered SIM. As described earlier, the user associated with the registered SIM corresponds to the owner of the mobile communication device 102. In a preferred embodiment, the customer information module 112 stores the user information for all the subscribers to the network. Such user information may also include an alternative MSISDN associated with the owner of the mobile communication device 102. The alternative MSISDN can be used to contact the owner or the user of the registered SIM for notification purposes. The network component 110 therefore sends the user information associated with the unregistered SIM via. one or more of a message, a mail, and a letter to the user associated with the registered SIM.

In an exemplary embodiment, both the registered SIM and the unregistered SIM subscribe to the same operator. In addition, it is generally a requirement for the subscriber to provide proper identification proof along with the user information at the time of subscribing to a service provider. Hence, the likelihood of positively determining the user information associated with the unregistered user is very high. In practice, the network operator can collect such user information by making one or more data fields compulsory for the subscriber to provide at the time of subscription. In comparison to the existing methods and systems for security of mobile communication devices, the user of the registered SIM would have the name, address, and other details of the user of the unregistered SIM and therefore can take necessary and prompt actions to obtain the mobile communication device.

There may be a possibility that the unregistered SIM subscribe and the registered SIM subscribe to different network operators. In such a case, the mobile component 108 sends a notification to the network component 110 in the operator subsystem 106 corresponding to the operator of the registered SIM. In an implementation, different operators may have a collaborative approach to this solution where the user information of such unregistered SIM can be made available by the operator of the unregistered SIM to the operator of the registered SIM. Since, security of mobile communication devices is a generic concern for one and all, such collaborations would be easy to implement. The network component 110 sends such user information to the user of the registered SIM as before. In a case where only the MSISDN of the unregistered SIM is available to operator subsystem 106 (corresponding to registered SIM's operator), the network component 110 would forward the MSISDN of the unregistered SIM to the user of the registered SIM. The user of the registered SIM can take necessary actions to determine the exact location and address of the unauthorized user of the mobile communication device.

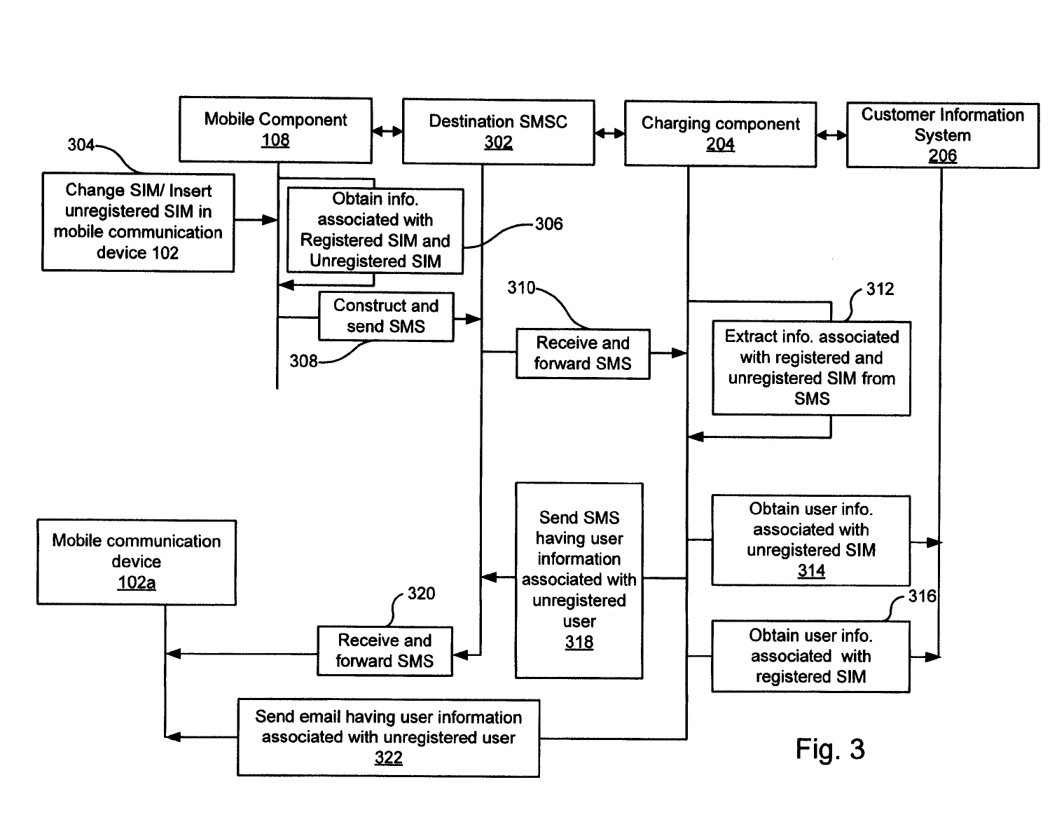

Referring to FIG. 3, an exemplary signaling diagram between modules of system 200 (of FIG. 2) is illustrated according to an implementation. The signaling diagram shows the communication and steps involved between the modules of system 200. As descried earlier, system 200 includes a mobile component 108, a charging subsystem 202, and a customer information system 206. A destination short message service center (SMSC) 302 is shown in FIG. 3 that receives an SMS notification from the mobile component 108 and sends the same to the charging component 204. Similarly, the destination SMSC 302 receives SMS having user information associated with the unregistered user and sends the same to alternate mobile communication device 102a associated with the user of the registered SIM.

Turning to FIG. 3, at 304, the user of the unregistered SIM removes the registered SIM and inserts the unregistered SIM into the mobile communication device 102. When the mobile communication device 102 is powered on with the unregistered SIM, the mobile component 108 detects the usage of the unregistered SIM. At 306, the mobile component 108 obtains user information associated with the registered SIM and the unregistered SIM. The detection includes comparing the obtained user information (MSISDN) associated with the registered SIM and the user information associated with the unregistered SIM. Based on the comparison, the mobile component 108 determines whether the SIM inserted in the mobile communication device 102 is registered or not. If not, then the mobile component 108, at 308, constructs an SMS and sends the same to a pre-determined destination SMSC 302. It may be appreciated that the mobile component 108 stores the destination SMSC details at the time of activation. Alternatively, the destination SMSC details can be pre-configured in the mobile component 108 when the user subscribes to the tracking service (provided by the service provider or the network operator).

At 310, the destination SMSC 302 receives the SMS from the mobile component 108 and forwards the same to the charging component 204. At 312, the charging component 204 receives the SMS from the destination SMSC 302 and extracts information associated with registered and unregistered SIM from the SMS. Based on the extracted information, the charging component 204 obtains user information associated with the unregistered SIM at 314. In an embodiment, the user information can correspond to the name, address, email ID, alternative phone number associated with the user of the unregistered SIM. At 316, the charging component 204 obtains user information associated with the registered SIM. In a successive progression, at 318, the charging component 204 sends SMS containing at least the user information associated with the user of unregistered SIM to the user of registered SIM. At 320, the destination SMSC 302 receives the SMS and forwards the same to the mobile communication device 102a associated with the user of the registered SIM or the owner of the mobile user. In an implementation, at 322, the charging component 204 sends an email to the registered SIM user having user information associated with the unregistered SIM user.

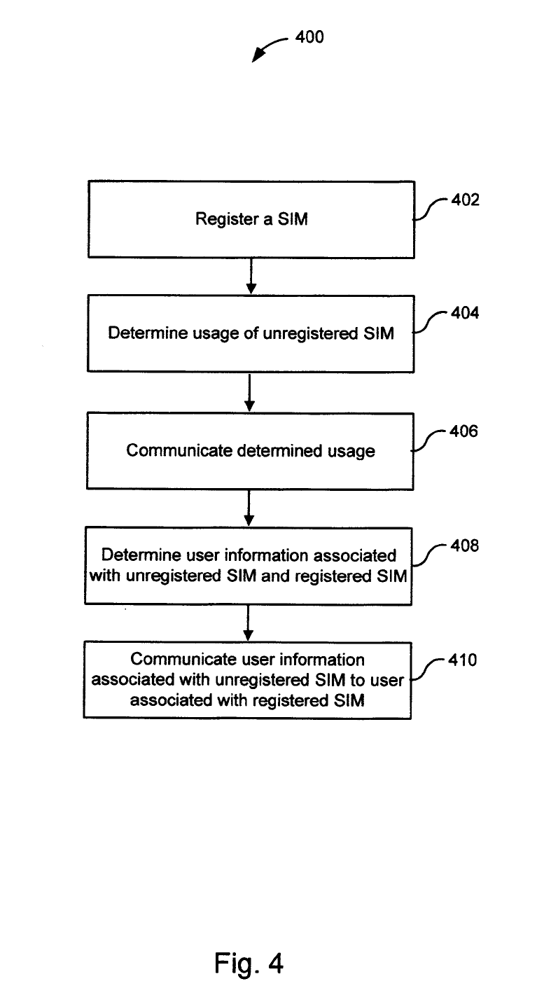

Turning to FIG. 4, an exemplary method 400 for determining information associated with an unregistered usage of a mobile communication device is illustrated. Accordingly, at block 402, a Subscriber Identification Module (SIM) is registered at the mobile communication device 102. In an embodiment, the registering includes storing a Mobile Station International ISDN Number (MSISDN) associated with the SIM.

At 404, usage of an unregistered SIM is determined at the mobile communication device 102. The determination is performed based at least in part on pre-stored information corresponding to the registered SIM. In an implementation, the determination includes comparing the Mobile Station International ISDN Numbers (MSISDN) associated with the unregistered Subscriber Identification Module and the registered Subscriber Identification Module.

At 406, the determined usage is communicated to an operator subsystem 106. In an implementation, communicating the determined usage includes constructing, at the mobile communication device 102, a message containing at least the Mobile Station International ISDN Numbers (MSISDN) associated with the registered SIM and the unregistered SIM.

At 408, user information associated with the registered SIM and the unregistered SIM are determined at the operator subsystem 106 based on the communication. In an embodiment, the user information includes one or more of name, home address, Mobile Station International ISDN Numbers (MSISDN), and email address of users associated with the registered Subscriber Identification Module (SIM) and the unregistered Subscriber Identification Module (SIM).

At 410, the user information associated with the unregistered SIM is communicated to a user associated with the registered SIM. In an embodiment, the communicating includes sending the user information associated with the unregistered SIM via. one or more of a message, a mail, and a letter to the user associated with the registered SIM.

Yet another embodiment of a system 100 for tracking unregistered usage of a mobile communication device 102 is disclosed. The mobile communication device 102 is pre-associated with a registered Subscriber Identification Module SIM. The system 100 includes a network component 110 executing at an operator subsystem 106 configured to receive a notification of unregistered usage from the mobile communication device 102. The network component 110 is further configured to determine user details associated with the unregistered usage and communicate the determined user details to a user associated with the registered SIM.

Still further embodiment of a method for determining unregistered usage of a mobile communication device 102 is disclosed. The mobile communication device 102 is pre-associated with a registered SIM. Accordingly, the method includes receiving a notification associated with detection of service initiation of an unregistered SIM in the mobile communication device 102. The notification includes Mobile Station International ISDN Numbers (MSISDN) corresponding to the registered SIM and the unregistered SIM respectively. The method also includes determining, based at least on the notification, the user details associated with the registered SIM and the unregistered SIM. The method also includes communicating the user details corresponding to unregistered SIM to a user associated with the registered SIM.

It will be appreciated that the number of components illustrated in FIG. 1 and FIG. 2 is exemplary. Other configurations with more, fewer, or a different arrangement of components may be implemented. Moreover, in some embodiments, one or more components in FIG. 1 and FIG. 2 may perform one or more of the tasks described as being performed by one or more other components in FIG. 1 and FIG. 2 respectively.

The foregoing description of implementations provides illustration and description, but is not intended to be exhaustive or limiting to the precise form disclosed. Modifications and variations are possible in light of the above teachings, or may be acquired from practice of the invention. For example, while series of blocks have been described with regard to FIGS. 3, and 4, the order of the blocks may be modified in other implementations consistent with the principles of the invention. Further, non-dependent blocks may be performed in parallel. In some implementations, more blocks may be added to the exemplary processes of FIG. 4.

Aspects of the invention may also be implemented in methods and/or computer program products. Accordingly, the invention may be embodied in hardware and/or in hardware/software (including firmware, resident software, microcode, etc.). Furthermore, the invention may take the form of a computer program product on a computer-usable or computer-readable storage medium having computer-usable or computer-readable program code embodied in the medium for use by or in connection with an instruction execution system. The actual software code or specialized control hardware used to implement embodiments described herein is not limiting of the invention. Thus, the operation and behavior of the aspects were described without reference to the specific software code—it being understood that one would be able to design software and control hardware to implement the aspects based on the description herein.

Furthermore, certain portions of the invention may be implemented as “logic” that performs one or more functions. This logic may include hardware, such as an application specific integrated circuit or field programmable gate array or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the invention unless explicitly described as such. Further, the phrase “based on” is intended to mean, “based, at least in part, on” unless explicitly stated otherwise.

While certain present preferred embodiments of the invention and certain present preferred methods of practicing the same have been illustrated and described herein, it is to be distinctly understood that the invention is not limited thereto but may be otherwise variously embodied and practiced within the scope of the following claims.

1. A method of determining information associated with an unregistered usage of a mobile communication device, the method comprising:
registering a Subscriber Identification Module (SIM) at the mobile communication device;
determining, at the mobile communication device, usage of an unregistered Subscriber Identification Module based at least in part on pre-stored information corresponding to the registered Subscriber Identification Module;
communicating the determined usage to an operator subsystem; and
determining, at the operator subsystem, based on the communication, user information associated with the registered Subscriber identification Module and the unregistered Subscriber Identification Module.

2. The method of claim 1, further comprising communicating the user information associated with the unregistered Subscriber Identification Module to a user associated with the registered Subscriber Identification Module.

3. The method of claim 1, wherein registering comprises storing a Mobile Station International ISDN Number (MSISDN) associated with the Subscriber Identification Module.

4. The method of claim 1, wherein the determining comprises comparing a Mobile Station International ISDN Number (MSISDN) associated with the unregistered Subscriber Identification Module with the registered Subscriber Identification Module.

5. The method of claim 1, wherein the Communicating the determined usage comprises constructing, at the mobile communication device, a message containing at least a Mobile Station International ISDN Numbers (MSISDN) associated with the registered Subscriber Identification Module (SIM) and the unregistered Subscriber Identification Module (SIM),

6. The method of claim 1, wherein the user information comprises one or more of name, home address, Mobile Station International ISDN Numbers (MSISDN), and email address of users associated with the registered Subscriber Identification Module (SIM) and the unregistered Subscriber Identification Module (SIM).

7. The method of claim 2, wherein communicating the user information comprises sending the user information associated with the unregistered Subscriber Identification Module (SIM) via one or more of a message, a mail, and a letter to the user associated with the registered Subscriber Identification Module (SIM).

8. A system for tracking usage of a lost mobile communication device, the mobile communication device pre-associated with a registered Subscriber Identification Module (SIM), the system comprising;
a mobile component installed in the mobile communication device configured to detect usage of an unregistered Subscriber Identification Module (SIM); and
a network component executing at an operator subsystem configured to:
receive a notification of the detected usage from the mobile component,
determine user details associated with the unregistered SIM, and
communicate the determined user details to a user associated with the registered Subscriber Identification Module (SIM).

9. The system of claim 8, wherein the mobile component comprises a JAVA based application.

10. The system of claim 8, wherein the network component comprises application software.

11. The system of claim 8, wherein the network component comprises a charging component in a charging system.

12. The system of claim 8, further comprising a customer information module configured to provide user details associated with the registered and unregistered Subscriber Identification Module (SIM).

13. The system of claim 12, wherein the customer information module comprises a proprietary customer information system.

14. The system of claim 8, wherein the mobile component is further configured to compare Mobile Station International ISDN Numbers (MSISDN) associated with the unregistered Subscriber Identification Module (SIM) and the registered Subscriber Identification Module (SIM).

15. The system of claim 8, wherein the unregistered Subscriber Identification Module (SIM) and the registered Subscriber Identification Module (SIM) subscribe to the same operator,

16. A system for tracking unregistered usage of a mobile communication device, the mobile communication device pre-associated with a registered Subscriber Identification Module (SIM), the system comprising;
a network component executing at an operator subsystem configured to:
receive a notification of unregistered usage from the mobile communication device;
determine user details associated with the unregistered usage,
communicate the determined user details to a user associated with the registered Subscriber Identification Module (SIM).

17. A method for determining unregistered usage of a mobile communication device, the mobile communication device pre-associated with a registered Subscriber Identification Module (SIM), the method comprising:
receiving a notification associated with detecting service initiation of an unregistered SIM in the mobile communication device, the notification comprising Mobile Station International ISDN Numbers (MSISDN) corresponding to the registered SIM and the unregistered SIM;
determining, based at least on the notification, user details associated with the registered SIM and the unregistered SIM; and
communicating the user details corresponding to the unregistered SIM to a user associated with the registered SIM.
